(19) United States
(12) Patent Application Publication
(10) Pub. No.: US 2015/0067406 A1
(43) Pub. Date: Mar. 5, 2015

(54) TESTING SYSTEM AND METHOD FOR FAN MODULE

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventor: KANG-BIN WANG, Shenzhen (CN)

(21) Appl. No.: 14/470,069

(22) Filed: Aug. 27, 2014

(30) Foreign Application Priority Data
Aug. 28, 2013 (CN) 2013103814454

(51) Int. Cl. G06F 11/27

(52) U.S. Cl. CPC G06F 11/27
USPC 714/40

(57) ABSTRACT

Testing system includes a testing device and a testing circuit board connected to the testing device. The testing device includes a storing module, a transmit-receive module, and an analyzing module. A number of specification parameters of a fan module is stored in the storing module. The transmit-receive module sends a testing code to the testing circuit board. The testing circuit board responds to the testing code to detect a number of running information of the fan module, and sends the running information to the transmit-receive module. The analyzing module receives the number of running information from the transmit-receive module and compares the number of running information with the number of specification parameters for determining whether the fan is qualified. The disclosure further provides a testing method.

### FIELD

Embodiments of the present disclosure relate to testing systems and methods, and particularly to a testing system and a testing method for a fan module.

### BACKGROUND

In most computer systems, it is necessary to include an additional cooling fan to dissipate heat generated by IC chips of the computer system. To ensure quality of the cooling fan, parameters of the cooling fan, such as a current value, a voltage value, and a vibration value of the cooling fan, are tested.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like-reference numerals designate corresponding parts throughout the several views.

FIG. 1 is a block diagram of one embodiment of a testing system.

FIG. 2 is a flowchart of one embodiment of a testing method using the testing system of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module,” as used hereinafter, refers to logic embodied in hardware or firmware, or to a collection of software instructions, written in a programming language, such as, for example, Java, C, or Assembly. One or more software instructions in the modules can be embedded in firmware. Modules can comprise connected logic units, such as gates and flip-flops, and programmable units, such as programmable gate arrays or processors. The modules described herein can be implemented as either software and/or hardware modules and can be stored in any type of computer-readable medium or computer storage device.

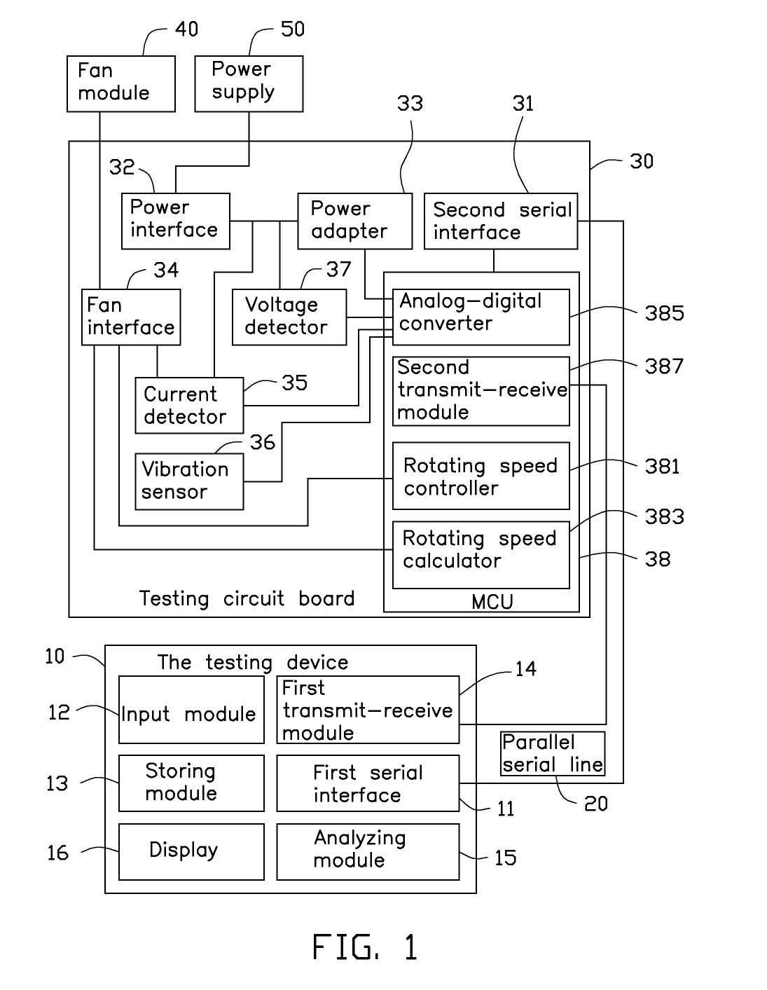

FIG. 1 illustrates one embodiment of a testing system. The testing system comprises a testing device 10, and a testing circuit board 30 connected to the testing device 10. In at least one embodiment, the testing device 10 is a personal computer that can be connected to the circuit board 30 by wires or wirelessly.

The testing device 10 comprises a first serial interface 11, an input module 12, a storing module 13, a first transmit-receive module 14, an analyzing module 15, and a display 16. The input module 12 is used to input a plurality of specification parameters of a fan module. In at least one embodiment, the plurality of specification parameters comprises a current specification value, a rotating speed specification value, a vibration specification value, a voltage specification value, and a power specification value. The storing module 13 is connected to the input module 12 and used to store the plurality of specification parameters. The first transmit-receive module 14 is used to send a testing code to the testing circuit board 30. The analyzing module 15 is used to compare a plurality of running information of a fan module 40 with the plurality of specification parameters in the storing module 13 to judge whether the fan module 40 is working properly. In at least one embodiment, the plurality of running information comprises a running current value, a running voltage value, a running vibration value, and a running power value. The running power value can be obtained according to the running current value and the running voltage value by the analyzing module 15. The display 16 is used to display a testing result, such as whether the fan module 40 is working properly or working improperly.

The testing circuit board 30 comprises a second serial interface 31 corresponding to the first serial interface 11, a power interface 32, a power adapter 33, a fan interface 34 connected to the power interface 32, a current detector 35, a vibration sensor 36, a voltage detector 37, and a microcontroller unit (MCU) 38. A parallel serial line 20 is connected to the first serial interface 11 and the second serial interface 31 for connecting the testing device 10 to the testing circuit board 30. The fan interface 34 is used for connecting the fan module 40 to the testing circuit board 30.

The power interface 32 is connected to the power adapter 33 and the fan interface 34, and is used for connecting to a power supply 50. The power supply 50 is used for supplying power to the fan module 40 and the MCU 38.

The power adapter 33 is connected to the MCU 38 and used for converting a voltage supplied by the power supply 50 into a voltage suitable for the fan module 40 and the MCU 38 to use.

The vibration sensor 36 is connected to the MCU 38 and used for detecting the running vibration value of the fan module 40.

The voltage sensor 37 is used for detecting the running voltage value of the fan module 40.

The MCU 38 comprises a rotating speed controller 381, a rotating speed calculator 383, an analog-digital converter 385, and a second transmit-receive module 387. The second transmit-receive module 387 is used for receiving the testing code from the first transmit-receive module 14, and sending the testing code to the rotating speed controller 381. The rotating speed controller 381 is connected to the fan interface 34 and used for controlling a rotating speed of the fan module 40. The rotating speed calculator 383 is connected to the fan interface 34 and used for counting the running rotating speed value of the fan module 40. The analog-digital converter 385 is connected to the current detector 35, the vibration sensor 36, and the voltage detector 37. The analog-digital converter 385 is used for receiving and converting the running current value, the running voltage value, and the running vibration value of the fan module 40 from an analog signal to a digital signal. When the analog-digital converter 385 has changed the analog signal of the running current value, the running voltage value, and the running vibration value into the digital signal, the second transmit-receive module 387 sends the digital signal of the running rotating speed value, the running current value, the running voltage value, and the running vibration value to the analyzing module 15. In at least one embodiment, the rotating speed controller 381 is a pulse-width modulator.

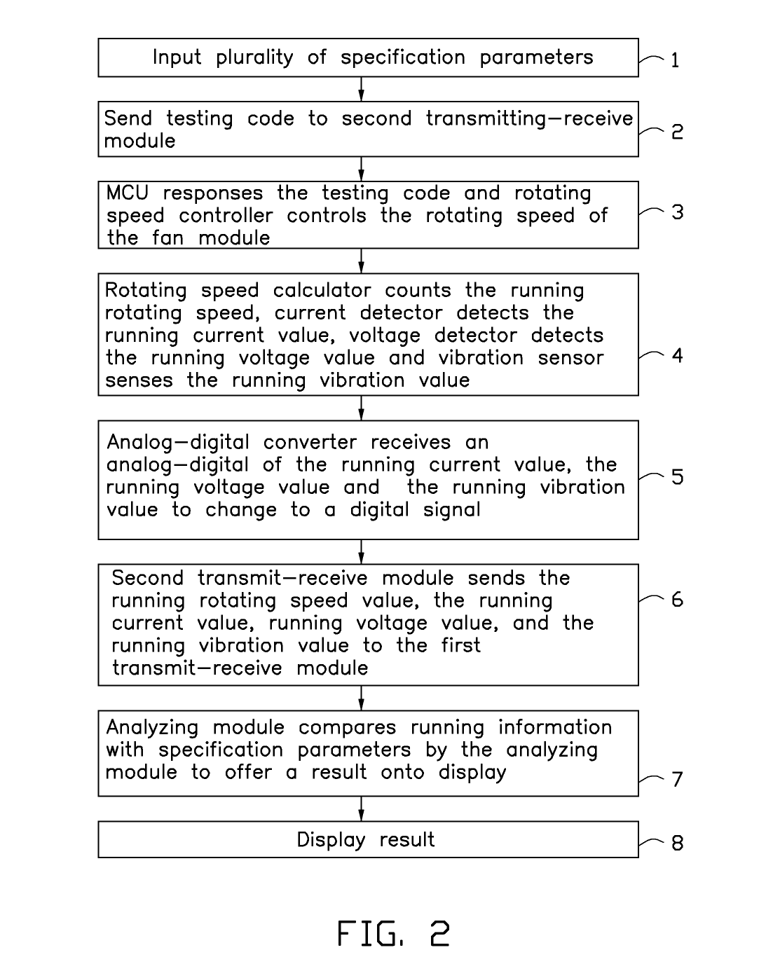

FIG. 2 is a flowchart of one embodiment of a testing method using the testing system in FIG. 1.

In block 1, the plurality of specification parameters is input by the input module.

In block 2, the first transmit-receive module sends a testing code to the second transmit-receive module of the MCU.

In block 3, the MCU sends the testing code to the rotating speed controller, and the rotating speed controller controls the rotating speed of the fan module.

In block 4, the rotating speed calculator counts the running rotating speed of the fan module, the current detector detects the running current value of the fan module, the voltage detector detects the running current value of the fan module, and the vibration sensor senses the running vibration value of the fan module.

In block 5, the analog-digital converter converts the running current value, the running voltage value, and the running vibration value of the fan module from an analog signal into a digital signal.

In block 6, the second transmit-receive module sends the digital running rotating speed value, running current value, running voltage value, and running vibration value to the first transmit-receive module.

In block 7, the first transmit-receive module sends the running rotating speed value, the running current value, the running voltage value, and the running vibration value to the analyzing module, and the analyzing module compares the running rotating speed value, the running current value, the running voltage value, and the running vibration value of the fan module with the rotating speed specification value, the current specification value, the voltage specification value, and the vibration specification value that are stored in the storing module. Simultaneously, a running power value is calculated according to the current specification value and the voltage specification value via the analyzing module and compared with the power specification value in the storing module. Then, the analyzing module sends a result to the display.

In block 8, when one of the running rotating speed value, the running current value, the running voltage value, and the running vibration value of the fan module does not conform to the rotating speed specification value, the current specification value, the voltage specification value, and the vibration specification value in the storing module, the fan module work improperly, and a result “not passed” can be displayed on the display. When each of the running rotating speed value, the running current value, the running voltage value, and the running vibration value of the fan module conforms to the rotating speed specification value, the current specification value, the voltage specification value, and the vibration specification value, respectively, the fan module work properly, and a result “passed” can be displayed on the display.

Each of the rotating speed specification value, the current specification value, the voltage specification value, and the vibration specification value stored in the storing module can be a range of values. When each of the running rotating speed value, the running current value, the running voltage value, and the running vibration value of the fan module is within the corresponding range of values stored in the storing module, the fan module can be work properly.

Although certain inventive embodiments of the present disclosure have been specifically described, the present disclosure is not to be construed as being limited thereto. Various changes or modifications may be made to the present disclosure without departing from the scope of the present disclosure or the following claims.

What is claimed is:

1. A testing system comprising:
a testing device comprising a storing module, a transmit-receive module, and an analyzing module; the storing module is configured for storing a plurality of specification parameters of a fan module, and the transmit-receive module is configured for sending a testing code; and
a testing circuit board connected to the testing device and configured for responding to the testing code to detect a plurality of running information of the fan module to the transmit-receive module;
wherein the analyzing module is configured to receive the plurality of running information from the transmit-receive module and compare the plurality of running information with the plurality of specification parameters for determining whether the fan is working properly.

2. The testing system of claim 1, further comprising an input module connected to the input module, wherein the input module is configured to input the plurality of specification parameters into the storing module.

3. The testing system of claim 1, wherein the plurality of specification value comprises a rotating speed specification value, a current specification value, a voltage specification value, and a vibration specification value, and the plurality of running information comprises a running rotating speed value, a running current value, a running voltage value, and a running vibration value.

4. The testing system of claim 3, further comprising a vibration sensor attached to the testing circuit board, wherein the vibration sensor is configured to detect the running vibration value of the fan module.

5. The testing system of claim 3, further comprising a microcontroller unit (MCU) attached to the testing circuit board, wherein the MCU is configured to detect the running rotating speed value, the running current value, and the running vibration value to the analyzing module.

6. The testing system of claim 5, wherein the MCU comprises a rotating speed calculator, and the rotating speed calculator is configured to connect the fan module to count the running rotating speed value.

7. The testing system of claim 5, wherein the MCU comprises an analog-digital converter, and the analog-digital converter is configured for changing an analog signal of the running current value, the running voltage value, and the running vibration value to a digital signal of the running current value, the running voltage value, and the running vibration value.

8. The testing system of claim 1, wherein the testing device further comprises a first serial interface, the testing circuit board further comprises a second serial interface, and the second serial interface is connected to the first serial interface via a parallel serial line.

9. A testing method comprising:
storing a plurality of specification parameters of a fan module by a storing module in a testing device;
sending a testing code by a transmit-receive module in the testing device;
responding to the testing code to detect a plurality of running information of the fan module to the transmit-receive module; and
receiving the plurality of running information from the transmit-receive module and comparing the plurality of running information with the plurality of specification parameters for determining whether the fan is working properly by an analyzing module in the testing device.

10. The testing method of claim 9, further comprising a block of inputting the plurality of specification parameters into the storing module by an input module in the testing device before the block of storing the plurality of specification parameters of the fan module by the storing module.

11. The testing method of claim 9, wherein the plurality of specification value comprises a rotating speed specification value, a current specification value, a voltage specification value, and a vibration specification value, and the plurality of running information comprises a running rotating speed value, a running current value, a running voltage value, and a running vibration value.

12. The testing method of claim 11, further comprising a block of detecting the running vibration value of the fan module by a vibration sensor attached to the testing circuit board when processing the block of responding to the testing code to detect the plurality of running information of the fan module to the transmit-receive module.

13. The testing method of claim 12, further comprising a block of detecting the running rotating speed value, the running current value, and the running vibration value to the analyzing module by a microcontroller Unit (MCU) attached to the testing circuit board.

14. The testing method of claim 13, further comprising a block of counting the running rotating speed value by a rotating speed calculator in the MCU when processing the block of responding to the testing code to detect the plurality of running information of the fan module to the transmit-receive module.

15. The testing system of claim 13, further comprising a block of changing an analog signal of the running current value, the running voltage value, and the running vibration value to a digital signal of the running current value, the running voltage value, and the running vibration value by an analog-digital converter in MCU when processing the block of responding to the testing code to detect the plurality of running information of the fan module to the transmit-receive module.

16. The testing system of claim 9, further comprising connecting a first serial interface of the testing device to a second serial interface of the testing circuit board via a parallel serial line before the block of sending a testing code by a transmit-receive module in the testing device.
